(19) United States
(12) Patent Application Publication
(10) Pub. No.: US 2006/0255804 A1
(43) Pub. Date: Nov. 16, 2006

(54) THREE CONCENTRIC COIL ARRAY

(75) Inventors: Dashen Chu, Hartland, WI (US); Ricardo M. Matias, Gainesville, FL (US); Robert S. Stormont, Hartland, WI (US)

Correspondence Address: JOSEPH S. HEINO, ESQ., 111 E. KILBOURN AVENUE, SUITE 1400, MILWAUKEE, WI, 53202, US

(73) Assignee: General Electric, Schenetady, NY (US)

(21) Appl. No.: 11/129,197

(22) Filed: May 13, 2005

(51) Int. Cl. G01V 3/00

(52) U.S. Cl. 324/318

(57) ABSTRACT

The present invention provides for a multiple station RF coil array comprised of multiple three concentric surface coil arrays for achieving a large field of view and high imaging resolution. Yet another embodiment of the invention provides for an RF coil array comprising three coil elements without sharing the same plane.

### BACKGROUND OF THE INVENTION

The present invention relates generally to magnetic resonance imaging (MRI) methods and devices, and more specifically, to a surface coil assembly for increasing the Signal to Noise Ratio (SNR) of an MRI machine.

Magnetic resonance imaging is based on the phenomenon of resonance of atomic nuclei. Resonance is defined as the increased amplitude of oscillation of a system exposed to a periodic force, the frequency of which is approximately equal to the system's natural frequency. Imaging involves measuring signals emitted from atomic nuclei in response to radio waves that have the same natural frequency as the nuclei themselves.

When a substance such as human tissue is subjected to a uniform magnetic field (polarizing field B₀), the individual magnetic moments of the spins in the tissue attempt to align with this polarizing field but precess about it in random order at their characteristic Larmor frequency. If the substance, or tissue, is subjected to a magnetic field (excitation field B₁) which is in the X-Y plane and which is near the Larmor frequency, the net aligned moment, M_{z}f, may be rotated, or “tipped”, into the X-Y plane to produce a net transverse magnetic moment Mₜ. A nuclear magnetic resonance (NMR) signal is emitted by the excited spins after the excitation signal B₁ is terminated and this signal may be received and processed to form an image.

Generally, the resulting radio frequency (RF) signals are detected by RF coil arrangements placed close to the body. Typically, such coils are surface type coils or volume type coils depending on the particular application. Normally, separate RF coils are used for excitation and detection but the same coil or array of coils may be used for both purposes.

Initially, NMR imaging systems utilized receiver coils which surrounded the entire sample (for example, a human patient) that was to be imaged. These remote coils had the advantage that the sensitivity was, to a first approximation, substantially constant over the entire region being imaged. While this uniformity in sensitivity is not strictly characteristic of such remote coils, the sensitivity is substantially constant to a sufficient degree that most reconstruction techniques assume a constant coil sensitivity. Because of their large size, the remote coils suffer from a relative insensitivity to individual spins.

For certain applications, a surface coil is preferable to a remote coil. Surface coils can be made much smaller in geometry than remote coils and for medical diagnostic use can be applied near, on, or inside the body of a patient. This is especially important where attention is being directed to imaging a small region within the patient, rather than an entire anatomical cross section. The use of a surface coil also reduces the noise contribution from electrical losses in the body, with respect to a corresponding remote coil, while maximizing the desired signal. NMR imaging systems thus typically use a small surface coil for localized high-resolution imaging.

A disadvantage of the surface coil, however, is its limited field of view. A single surface coil can only effectively image that region of the sample having lateral dimensions comparable to the surface coil diameter. Therefore, the surface coil necessarily restricts the field of view and inevitably leads to a tradeoff between resolution and field of view. The size of the surface coil is constrained by the intrinsic SNR of the coil. Generally, larger coils induce greater patient sample losses and therefore have a larger noise component, while smaller coils have lower noise but in turn restrict the field of view to a smaller region.

Further improvements in the SNR can be obtained through use of quadrature coils such as birdcage coils and a pair of saddle-shaped coil and loop coil. Quadrature coils transmit a radio pulse whose magnetization rotates in a full circle with the proton spins. Quadrature coils provide a large reduction in RF power deposition and increased SNR.

Unfortunately, the use of such coils effectively limits the imaging area to the dimensions of the surface coil. Larger surface coils induce greater patient sample losses and therefore have higher noise resistance. Therefore, it is highly desirable to provide a set of surface coils arrayed with overlapping fields of view. At the same time, it is desirable to maintain the high SNR of the single surface coil, which requires that coil interactions be minimized.

Previous efforts to employ more than three surface coils located in the same plane and decoupled from one another have not resulted in an improvement in SNR over conventional quadrature coils. Prior arrangements have provided for a third large coil arranged over two adjacently overlapped coils. While the larger third coil may improve the SNR, only one of the three coils contributes an optimum B₁ field. Additionally, such a large third coil increases the noise without providing the B₁ field contribution of the smaller coils.

### SUMMARY OF THE INVENTION

The present invention provides a new and unique coil arrangement that improves the SNR ratio of multiple coil arrays. The present invention provides for a coil array having two concentric surface coils. The first coil in such an arrangement is called a “double butterfly” coil and will be explained in detail in the detailed description. The double butterfly coil is paired in combination with a loop coil. The net magnetic flux through the double butterfly coil is adjustable to zero by varying the size of the loops of the butterfly coil in relation to one another. The present invention also provides for a coil array having two concentric coils, a double butterfly coil and a butterfly coil.

The present invention may further provide for a three concentric coil array wherein all three coils share the same field of view, the three concentric coil array comprising a double butterfly coil, a butterfly coil overlaying the double butterfly coil and a loop coil overlaying both the double butterfly coil and the butterfly coil.

The present invention provides for three mutually inductively decoupled concentric surface coil array which allows each coil to contribute to an optimum B, field in the region of interest. This new and unique coil array provides for increased SNR. The new coil array also eliminates the magnetic coupling between the double butterfly coil and a loop coil. In a yet another embodiment, the coil array eliminates the magnetic coupling between the double butterfly coil and a butterfly coil. The present invention also provides for the use of phase array technology to provide for an improvement in SNR over a linear surface coil, and even an SNR improvement over a pair of quadrature coils in the region where all three B, fields and noises are comparable.

The present invention provides for a multiple station RF coil array comprised of multiple three concentric surface coil arrays for achieving a large field of view. Yet another embodiment of the invention provides for an RF coil array comprising three coil elements without sharing the same plane.

### BRIEF DESCRIPTION OF THE DRAWINGS

FIG. 1 represents a schematic view of the coil disclosed by Srinivasan.

FIG. 2 represents a schematic view of the coil disclosed by Boskamp, et al.

FIG. 3A is a top schematic view of a double butterfly coil constructed in accordance with the present invention.

FIG. 3B is an axial view of the double butterfly coil indicating the direction of current flow through the coil.

FIG. 4 is a schematic view of a double butterfly coil overlaid by a concentric loop coil.

FIG. 5 is a schematic view of a butterfly coil overlaid by a concentric double butterfly coil.

FIG. 6 is a schematic view of a third concentric loop coil overlaying the double butterfly coil and the butterfly coil of FIG. 5.

FIG. 7 shows field profile graphs for a butterfly coil, a double butterfly coil, a loop coil and the combined field profile.

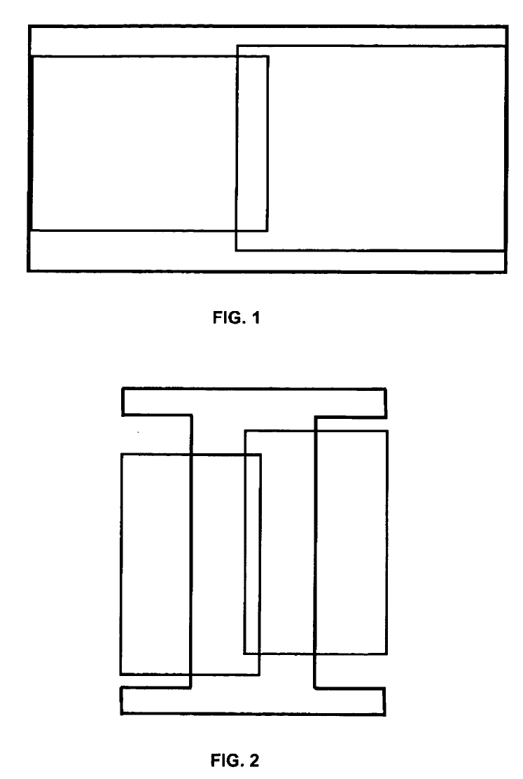

### DETAILED DESCRIPTION

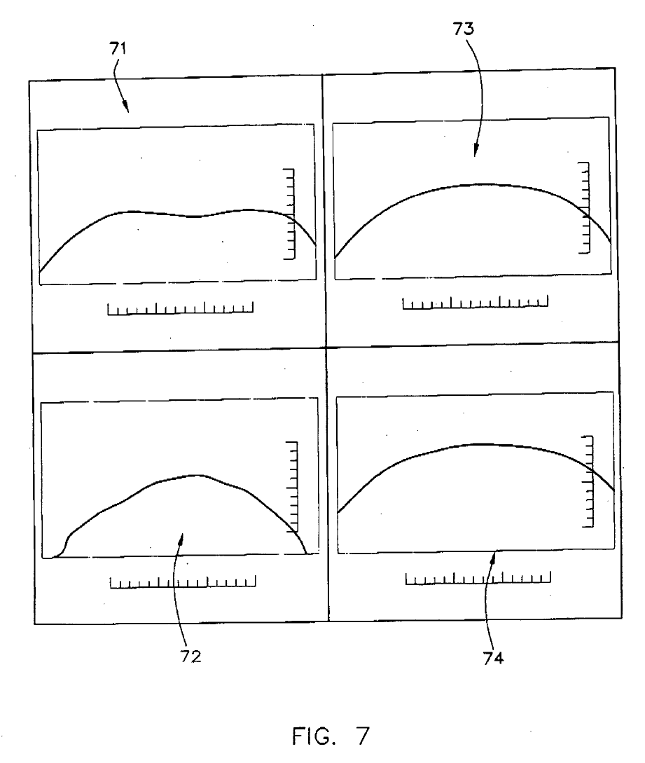

Now referring to the drawings in detail, wherein like numbers correspond to like elements throughout, FIG. 6 shows one embodiment of a three coil concentric array 60 of the present invention. In short, the invention consists of three concentric surface coils, e.g., a butterfly coil 61, a double butterfly coil 62 and a loop coil 63.

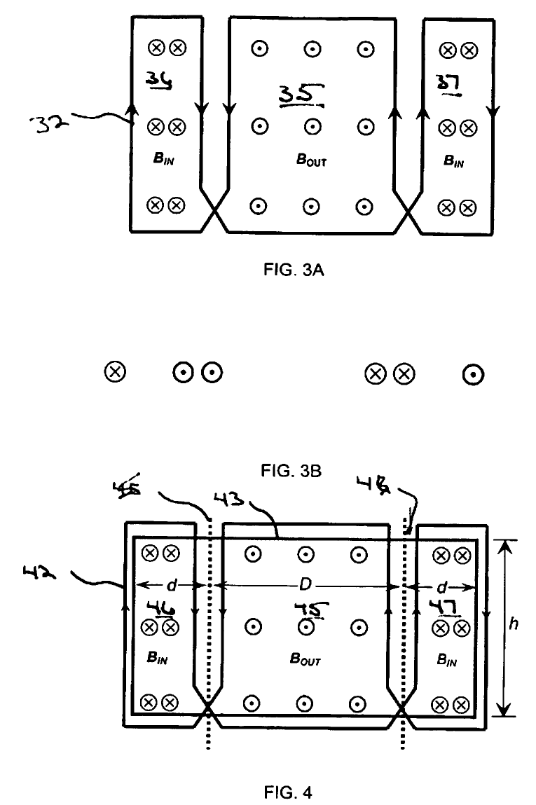

Now referring back to FIGS. 3A and 3B, which show a “double butterfly” coil as used in the present invention. Given a current/running through the double butterfly coil 32 as shown in FIG. 3A, the B₁ field will be generated symmetrically about its axis. Therefore, there are two opposite B₁ fields, that is, Bout inside the center window and Bᵢₙ inside the side windows 36, 37 which are disposed on both the left and right side respectively of the center window 35 as shown in FIG. 3B.

FIG. 4 shows a double butterfly coil 41 overlapping a loop coil 43 concentrically. The B₁ field from the double butterfly coil 41 penetrates into the loop coil 43 from two opposite directions. Therefore, the net magnetic flux φ over the loop coil 43 is the difference of the magnetic flux inward (φᵢₙ) and the magnetic flux outward (φₒᵤₜ) and can be represented as:

$$Φ = {Φ}_{in} - {Φ}_{out}$$

$$Φ = 2 {\int }_{s} {B}_{in} ⅆ s - {\int }_{s} {B}_{out} ⅆ s$$

$$Φ = 2 {\int }_{0}^{h} {\int }_{0}^{d} {B}_{in} ⅆ y ⅆ x - {\int }_{0}^{h} {\int }_{0}^{d} {B}_{out} ⅆ y ⅆ x$$

This relationship is dependent on the relationship of the width of center window 45 to the width of the side windows 46, 47, as shown, the distances D and d. Using these equations, it is possible to set the net magnetic flux to zero by adjusting the ratio between the distances D and d to realize magnetic decoupling between the coils.

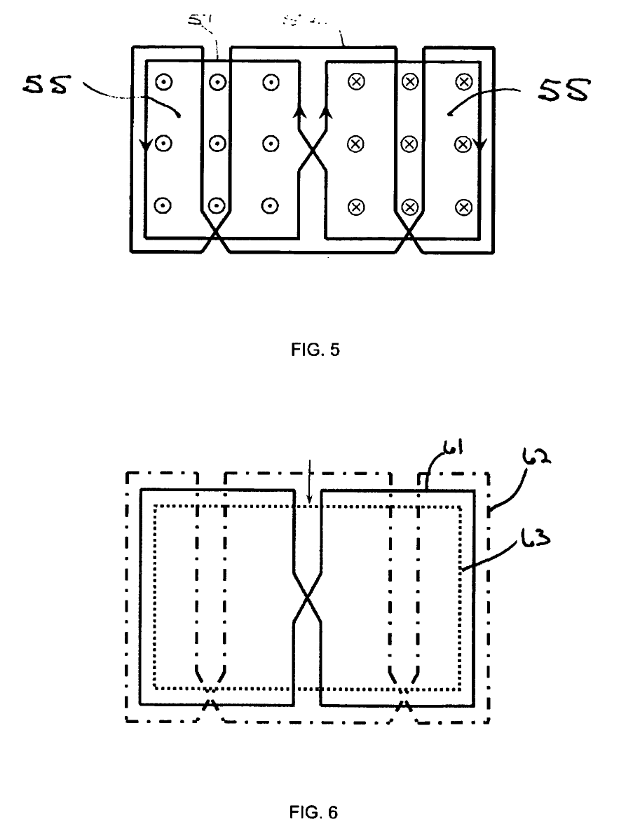

Because a butterfly coil 51 always generates an opposite B₁ field in each window 55 of the butterfly coil 51, if a double butterfly coil 52 shares the same axis as in FIG. 5, the net magnetic flux through the double butterfly coil 52 will be zero. Therefore, magnetic decoupling of the coils can be realized with any coil size.

The elimination of magnetic coupling between the double butterfly coil and a loop coil or a butterfly coil provides for establishment of an inductively decoupled concentric surface coil array, as represented in FIG. 5, which shows a double butterfly coil 52 overlapping a butterfly coil 51. This allows each of the coils 51, 52 to contribute to the optimum B₁ field in the region of interest.

The present invention may also provide for a three coil array wherein all three coils share the same geometric center and provide a √3 improvement in the signal to noise ratio over a linear surface coil, which is equivalent to a 22% improvement over a pair of quadrature coils in the region where all three B₁ fields and noises are comparable. FIG. 6 shows such an embodiment with one potential coil arrangement wherein a butterfly coil 61, a double butterfly coil 62 and a loop coil 63 are employed in a concentric arrangement to contribute an optimum B, field in the region on interest.

FIG. 7 illustrates the specific signal strength and field homogeneity achieved using a butterfly coil individually 71, a loop coil individually 73 and a double butterfly coil individually 72. The bottom right schematic is shows the improved signal strength and field homogeneity providing by using a combination of the coils 61, 62, 63 such as shown in FIG. 6. There are a number of potential variations of the present invention. For example, one embodiment may comprise a multiple-station RF coil array comprising multiple three-coil concentric surface arrays for achieving larger fields of view. In this particular embodiment, coils of adjacent arrays may overlap each other. Yet another potential embodiment may include the same three coil elements, that is, some combination of concentric coil elements, but it should be noted that the coil elements need not necessarily share the same plane. Additionally, the present invention may further comprise an RF coil array comprising one double butterfly coil and one loop coil or a butterfly coil.

Additional advantages and modifications will readily occur to those skilled in the art. Therefore, the invention in its broader aspects is not limited to the specific details disclosed and described herein. Accordingly, various modifications may be made without departing from the spirit or scope of the general inventive concept as defined by the appended claims and their equivalents.

What is claimed is:

1. A radio frequency (RF) coil array for resonance imaging, comprising:
a double butterfly RF coil; and
a loop coil concentrically overlapping the double butterfly coil.

2. The RF coil array of claim 1 wherein the double butterfly coil is comprised of an equivalent center loop of width D and two equivalent side loops of width d, and the net magnetic flux through the coil is adjustable to zero by adjusting the ratio between the widths D and d according to the relationship;
$$Φ = {Φ}_{in} - {Φ}_{out}$$
$$Φ = 2 {\int }_{s} {B}_{in} ⅆ s - {\int }_{s} {B}_{out} ⅆ s$$
$$Φ = 2 {\int }_{0}^{h} {\int }_{0}^{d} {B}_{in} ⅆ y ⅆ x - {\int }_{0}^{h} {\int }_{0}^{d} {B}_{out} ⅆ y ⅆ x .$$

3. The RF coil array of claim 2 further comprising a butterfly coil concentrically overlapping the double butterfly coil and the loop coil, the butterfly coil sharing the same axis of symmetry with the double butterfly coil.

4. The RF coil array of claim 2 wherein the double butterfly coil and the loop coil share the same or similar field of view.

5. A radio frequency (RF) coil array for resonance imaging comprising:
a double butterfly RF coil; and
a butterfly RF coil concentrically overlapping the double butterfly RF coil, the double butterfly RF coil and the butterfly RF coil sharing an axis of symmetry.

6. The RF coil of claim 5 wherein the double butterfly coil is comprised of an equivalent center loop of width D and two equivalent side loops of width d, and the net magnetic flux through the loop coil and the double butterfly coil is adjustable to zero by adjusting the ratio between the widths D and d according to the relationship;
$$Φ = {Φ}_{in} - {Φ}_{out}$$
$$Φ = 2 {\int }_{s} {B}_{in} ⅆ s - {\int }_{s} {B}_{out} ⅆ s$$
$$Φ = 2 {\int }_{0}^{h} {\int }_{0}^{d} {B}_{in} ⅆ y ⅆ x - {\int }_{0}^{h} {\int }_{0}^{d} {B}_{out} ⅆ y ⅆ x .$$

7. The RF coil array of claim 6 wherein the loop coil, the double butterfly coil and the butterfly coil share the same or similar field of view.

8. A multiple station radio frequency (RF) coil array comprising:
a plurality of RF coil arrays each comprising:
a butterfly coil;
a double butterfly coil concentrically overlapping the butterfly coil; and
a loop coil concentrically overlapping both the butterfly coil and the double butterfly coil.

9. The multiple station RF coil array of claim 8 wherein the double butterfly coil is comprised of an equivalent center loop of width D and two equivalent side loops of width d, and the net magnetic flux through the loop coil and the double butterfly coil is adjustable to zero by adjusting the ratio between the widths D and d according to the relationship;
$$Φ = {Φ}_{in} - {Φ}_{out}$$
$$Φ = 2 {\int }_{s} {B}_{in} ⅆ s - {\int }_{s} {B}_{out} ⅆ s$$
$$Φ = 2 {\int }_{0}^{h} {\int }_{0}^{d} {B}_{in} ⅆ y ⅆ x - {\int }_{0}^{h} {\int }_{0}^{d} {B}_{out} ⅆ y ⅆ x .$$

10. The multiple station RF coil array of claim 8 wherein each individual coil in the coil array has the same or similar field of view.

11. The multiple station RF coil array of claim 8 wherein the double butterfly RF coil and the butterfly RF coil share an axis of symmetry.

12. The multiple station RF coil array of claim 8 wherein adjacent coil arrays partially overlap one another.

13. A multiple station radio frequency (RF) coil array comprising:
a plurality of RF coil arrays each comprising:
a butterfly coil;
a double butterfly coil concentrically overlapping the butterfly coil, the double butterfly coil being comprised of a center loop of width D and two side loops of width d; and
a loop coil concentrically overlapping both the butterfly coil and the double butterfly coil, the net magnetic flux through the loop coil and the double butterfly coil is adjustable to zero by adjusting the ratio between the widths D and d according to the relationship;
$$Φ = {Φ}_{in} - {Φ}_{out}$$
$$Φ = 2 {\int }_{s} {B}_{in} ⅆ s - {\int }_{s} {B}_{out} ⅆ s$$
$$Φ = 2 {\int }_{0}^{h} {\int }_{0}^{d} {B}_{in} ⅆ y ⅆ x - {\int }_{0}^{h} {\int }_{0}^{d} {B}_{out} ⅆ y ⅆ x .$$

14. The multiple station RF coil array of claim 13 wherein adjacent coil arrays partially overlap one another.
